(19) United States
(12) Patent Application Publication
(10) Pub. No.: US 2007/0294137 A1
(43) Pub. Date: Dec. 20, 2007

(54) CUSTOM ORDER MANAGER

(75) Inventor: Donna R. Zett, Village of Lakewood, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Serta, Inc., Hoffman Estates, IL (US)

(21) Appl. No.: 11/758,521

(22) Filed: Jun. 5, 2007

Related U.S. Application Data
(60) Provisional application No. 60/814,779, filed on Jun. 19, 2006.

(51) Int. Cl. G06Q 30/00

(52) U.S. Cl. 705/26

(57) ABSTRACT

A method is provided of displaying the progress, through a plurality of separate entities each externally linked by a network to a display and a data repository, of an order for a product. The method comprises receiving purchase order information, order status information, manufacturing status information associated with the order, and shipper status information. This information is stored in the data repository and in response to user input, at least a current status of the purchase order information, the order status information, the manufacturing status information, and the shipper status information, is displayed on the display.

### CROSS-REFERENCE TO RELATED PATENT APPLICATIONS

This patent application claims the benefit of U.S. Provisional Patent Application No. 60/814,779, filed Jun. 19, 2006.

### FIELD OF THE INVENTION

This invention pertains to an order management system for products that are custom made or manufactured just in time.

### BACKGROUND OF THE INVENTION

The invention is directed to a method of managing an order, from inception through delivery, for a product that is manufactured after the order is placed. Products particularly suited for this method are those that are custom made according to the customer's particular specifications and products that are manufactured in a just in time environment. In both scenarios the product is not carried in inventory and is manufactured after the customer places the order.

In the first scenario, the custom order, the characteristics of the product are not fully known until the order is placed; consequently, the product cannot be manufactured until that time. In a just in time environment, products are not manufactured until after order has been placed for efficiency and economic reasons. Among other benefits, manufacturing in a just in time environment eliminates the problems associated with having to carry products in inventory due to overestimation of the amount of demand for the product, the timing of the demand for the product, or the consumer interest in the product. Excess or unwanted inventory ties up available capital, increases costs, and lowers profits.

Nevertheless, manufacturing on demand has its challenges, especially with regard to managing customer and retailer inquiries regarding the status of the product. There are many steps that must be accomplished between order placement and product delivery when a product is not simply shipped out of inventory, and the complexity of providing status information increases with the number of entities involved in the total process. Suppliers of these products have become increasingly decentralized and it is not uncommon for a retailer to place the order with a supplier who uses a local manufacturer make the good, and a local delivery company, otherwise known as a shipper, to deliver the product. When customers want to know the status of their orders, the retailer calls the supplier, who, in turn, calls the manufacturing company or the shipper to determine at which stage in the process the product is. This invention provides each of the different entities involved, including the customer, the ability to determine at a glance the status of the product.

### BRIEF SUMMARY OF THE INVENTION

The invention is directed to a method of managing an order, from inception through delivery, for a product that is manufactured after the order is placed. In one embodiment, a method is provided for displaying the progress, through a plurality of entities, of an order for a product not carried in inventory. Each entity may be a separate entity externally linked by a network to a display and a data repository. The method comprises receiving purchase order information generated by a first entity of the plurality of entities; receiving order status information, generated by a second entity of the plurality of entities, indicating that the order has been received by the second entity; receiving, from a third entity of the plurality of entities, manufacturing status information associated with the order; receiving, from a fourth entity of the plurality of entities, shipper status information associated with the order; storing in the data repository the received purchase order information, order status information, manufacturing status information, and shipper status information; and in response to user input, displaying on the display at least a current status of the purchase order information, the order status information, the manufacturing status information, and the shipper status information. The purchase order information generated by the first entity may comprise identification of the product, a customer's name, and a delivery address for the product. In another embodiment of the invention, information that is displayed can be updated by at least one of the entities. In yet another embodiment, the information received may be stored in a first database and a second database and the databases may be synced such that differences in the information are recognized and resolved. An advantage of the present invention is that it provides a method for each of the different entities involved to determine the status of the product. This and other advantages of the invention will be apparent from the description of the invention provided herein.

### BRIEF DESCRIPTION OF THE DRAWINGS

FIG. 1 is a schematic diagram of one implementation of an embodiment of the invention.

FIG. 2 is a diagram showing one embodiment of the display.

FIG. 3 is one embodiment of the update information screen.

FIG. 4 is one embodiment of the order exact replacement screen.

FIG. 5 is one embodiment of the cancel screen.

FIG. 6 is one embodiment of the warranty screen.

FIG. 7 is a schematic diagram of another implementation of an embodiment of the invention.

### DETAILED DESCRIPTION OF THE INVENTION

The following examples further illustrate the invention but, of course, should not be construed as in any way limiting its scope. The method of the invention comprises receiving purchase order information generated by a first entity wherein the purchase order information identifies the product or products that have been ordered, the customer (or member) who ordered the products, and the delivery information; receiving order status information generated by a second entity wherein the order status information is related to the purchase order information; receiving manufacturing status information, generated by a third entity, related to the purchase order information; receiving shipper status information, generated by a fourth entity, related to the purchase order information; and in response to user input, displaying on a web based display at least the current status of the purchase order information, the order status information, the manufacturing status information, and the shipper status information. In a preferred embodiment of the invention the first entity is a retailer, the second entity is a supplier, the third entity is a manufacturer, and the fourth entity is a shipper. User input to trigger the display of information can be provided by any of the above entities as well as a fifth entity such as a customer. Furthermore, in another embodiment of the invention, information that is displayed can be updated by at least one of the entities above.

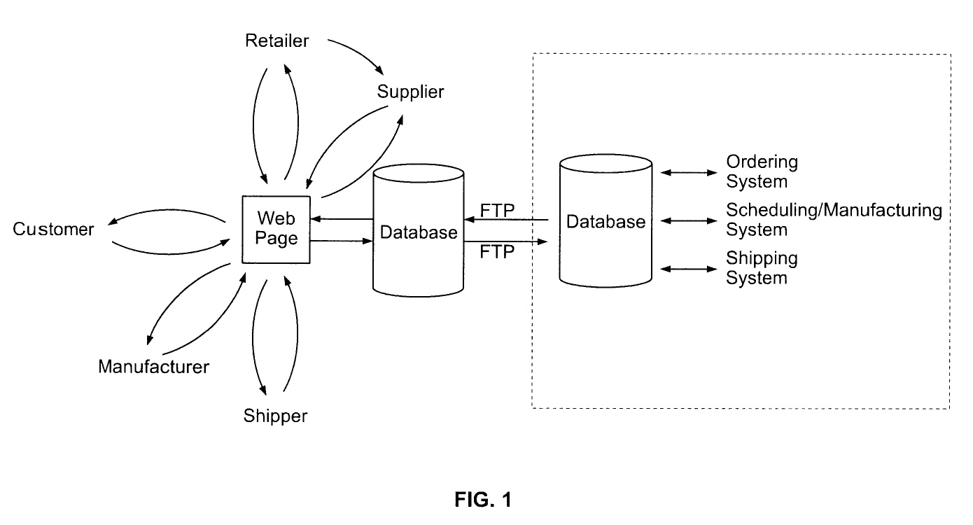

FIG. 1 is a schematic diagram of one implementation of an embodiment of the invention. FIG. 1 shows a plurality of entities connected via a computer network such as the Internet, to view a display which graphically depicts the status of a product order. The entities may be entities such as a retailer, a supplier, a manufacturer, a shipper and a customer. Although in this particular example only one retailer, supplier, manufacturer, shipper, and customer are shown, a plurality of each of these entities may connect to the display. Furthermore, other embodiments of this invention may have other combinations of entities, fewer entities connecting to the network, or entities networked in other combinations with each other. In this embodiment, the display is a web page, hosted on a server. The server has a data repository, such as a database, associated with it that exchanges data with another server to which is connected a second data repository such as a database. In this particular embodiment, the databases depicted in FIG. 1 may be managed by the supplier or another entity. The database associated with the web page server, the first database, is a relational SQL (Structure Query Language) database. The second database is connected to the supplier's ordering, scheduling/manufacturing, and shipping systems. SQL is used to store and retrieve data stored in the first database which uses a SQL database program. Other databases, database programs, and programming languages could be used as well.

The web page is updated periodically with data from the first database which receives updates from the second database. Preferably, the web page is updated every 15 minutes but other update intervals could be used as well. The first database receives data such as purchase order information, order status information, manufacturing status information, and shipper status information. In this embodiment that data originates from various other supplier systems such as ordering systems and scheduling systems as well as direct input into the web page. The data received may be stored in the first database.

Furthermore, in addition to displaying data to the entities, the web page also may receive data input from at least some of the entities. In this embodiment, the web page may receive data input by the customer, the retailer, the shipper, and the supplier. Other combinations of entities entering data into the display could also be used. For instance, the manufacturer may also enter data into the web page. Once the data is entered into the web page, it is transferred to the first database and then to the second database. Any suitable method of downloading (or uploading) data can be used. According to one embodiment, File Transfer Protocol (FTP) in a comma delimited format is used to download the data from the web page to the first database and then to the second database and vice versa. According to an embodiment, the information in the databases and the web page may be periodically “synced” such that differences in the data are recognized and resolved. For example, if a customer accesses the web page and updates or corrects their address information, during a syncing cycle this difference will be recognized and the new address information may be applied to a database.

In the embodiment depicted in FIG. 1, purchase order information is generated by the retailer when the customer, or member, places an order for a product or products. The retailer may be a retail establishment or an on-line retailer accessed by a customer over the Internet. The purchase order information is transmitted to the supplier from the retailer through an ordering system such as Electronic Data Interchange (EDI) or any other method. The order passes through a number of steps at various entities until the product is finally delivered. Delivery may be made to the retailer or to the end customer. This invention is a method of managing the order by providing status information for the order as it progresses from order placement through the various stages at the various entities until the product is delivered.

According the method, purchase order information is received by the first database depicted in FIG. 1. In the embodiment depicted in FIG. 1 it is retailer purchase order information. For example, the information may include, identification of the product the customer has ordered, the customer name, the delivery address, the home phone number, the cell phone number, the customer's email address, the retailer identification, the retailer employee identification number, the employee name, the employee email address, and the purchase order number. Identification of the product ordered includes information such as the UPC number or SKU for each item, the quantity of each item, and the description of each item.

The first database of FIG. 1 also receives order status information, in this embodiment it is supplier order status information, indicating the date and time the order was received by the supplier, and the date and time the order was verified and sent by the supplier to the manufacturer. In other embodiments of the invention, other information may be supplied.

The first database of FIG. 1 also receives manufacturing status information which may include the date and time the order was received by the manufacturer, the date and time the order entered production, the date the order is scheduled to ship from the manufacturer to the shipper, and the date the finished product ships from the manufacturer. In other embodiments of the invention, other information may be supplied.

The first database of FIG. 1 also receives shipper status information which may include the name, address and phone number of the shipper, the shipper way bill number, the date and time the shipper received the product, the date and time the customer (or member) was contacted to set up a delivery date, the scheduled delivery date and time, and the date and time of delivery of the product by the shipper. In other embodiments of the invention, other information may be supplied.

Other data that may be received by the first database can include information indicating that the customer has cancelled the delivery, information indicating that there is a customer information problem, and information resolving a customer information problem and the date and time that the customer information problem was resolved. In the embodiment of FIG. 1, cancellation data can be entered by the retailer, the supplier, or the shipper into the web page. Other embodiments may allow different entities to enter cancellation data into the web page. This data is then passed to the first database. Information indicating that there is a customer information problem can be entered by the customer, retailer, supplier, manufacturer, or shipper, although in the embodiment in FIG. 1, the information is entered by the supplier into systems that then pass that data to the second database and from there the information is passed to the first database and the web page. In this embodiment, the data relating to the date and time that a customer information problem was resolved can be entered by the customer, the retailer, the supplier, or the shipper into the web page although in other embodiments a different combination of entities may enter this information into the web page. This data is then passed to the first database.

An entity accesses the web page through accessing a web site on the network. The web site may be secured by a login name and password. Once logged onto the site, orders can be searched using various criteria. Examples of such criteria include the purchase order number, the shipper waybill number, the customer phone number, or the customer last name. The first database is searched and information associated with the search criteria is returned. If the search criteria matches more than one record stored in the first database then a list of possibilities is presented. If the searcher is a retailer the list will include only those customers that placed their order through that retailer. In one embodiment, a list of possibilities will display information such as the purchase order number, the way bill number, the customer's last name, city, state, zip code and phone number will appear in a list of possibilities. The correct entry can then be selected from the list and then at least some current status information will be displayed for the order on a web page. If the searcher is a customer, the search criteria are the waybill number or purchase order number and the customer's zip code.

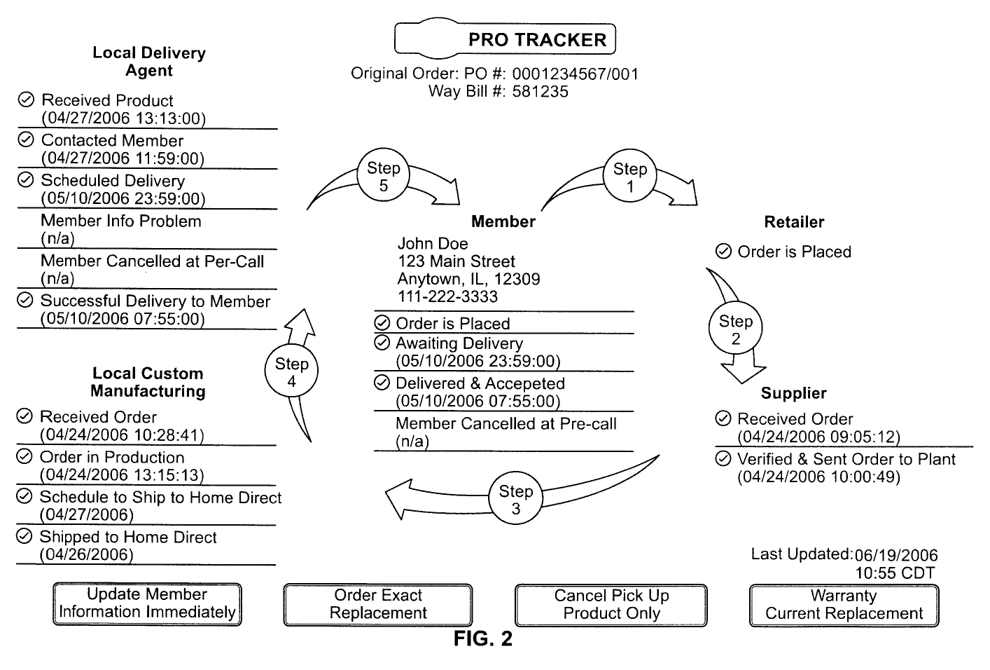

The web page, in response to this user input, displays the current status information related to each entity. For the embodiment of FIG. 1, at least the current status information is displayed for retailer purchase order information, supplier status information, manufacturer status information, and delivery status information. FIG. 2 is one embodiment of the web page display for FIG. 1. In FIG. 2, at least the current status information for the retailer purchase order information, supplier status information, manufacturer status information, and delivery status information is displayed along with a graphic representation of the sequence of the functions of the customer, the retailer, the supplier, the manufacturer, and the shipper in the order fulfillment process. Retailers can stay logged in for as long as they want. Customers will be timed out after 3 minutes and must log in again to continue viewing the display. The web page information, in this embodiment, is updated every 15 minutes but may be updated at shorter or longer intervals of time or may be updated dynamically.

As shown in FIG. 2, the web page display depicts icons that represent each of the entities involved and the display indicates with arrows and the labeling of “steps” the sequential order of each entity's role in the order fulfillment. In FIG. 2, the display has a customer icon, a retailer icon, a supplier icon, a manufacturer icon and a shipper icon. There is an arrow, labeled “Step 1,” pointing from the customer icon to the retailer icon. There is an arrow, labeled “Step 2,” pointing from the retailer icon to the supplier icon, an arrow, labeled “Step 3,” pointing from the supplier icon to the manufacturer icon, an arrow, labeled “Step 4,” pointing from the manufacturer icon to the shipper icon, and an arrow, labeled “Step 5,” pointing from the shipper icon to the customer icon. When each entity in the process completes their functions, the arrow between that entity and the next in the process is changed from gray to green. The colors and particular functions may vary for different implementations of the invention.

Adjacent to each entity icon are stage icons that identify various stages associated with each entity. Each stage icon, in the embodiment depicted in FIG. 2, is a circle with a checkmark inside it. Next to the stage icon is a related line of text identifying the stage that the icon represents. As each stage associated with an entity is completed, the stage icon associated with that stage changes color. In the embodiment in FIG. 2, the secondary icon changes from gray to green, although other colors could be used in other embodiments. Additionally, in other embodiments of this invention, as soon as a stage icon is changed to green, flashing text reading “PENDING” appears adjacent to the next stage icon in the order fulfillment process.

Adjacent to the customer icon is the customer's name and address and phone number. Below the phone number are four customer stage icons. The first customer stage icon has a text label of “Order is placed,” the second customer stage icon has a text label of “Awaiting Delivery,” the third customer stage icon has a text label of “Delivered & Accepted,” and the fourth customer stage icon has a text label of “Member Cancelled at Pre-Call.” When the web page receives data indicating the customer has placed an order, the first customer stage icon changes color from gray to green, and the arrow between the customer icon and the retailer icon changes from gray to green. When the web page receives data indicating that the shipper scheduled a delivery date with the customer (member), the second customer stage icon changes color from gray to green and the scheduled date and time of delivery appears next to the second customer stage icon. When the web page receives data indicating that the product has been delivered and accepted by the customer, the third customer stage icon changes color from gray to green and the delivery date and time appears next to the third customer stage icon. If the web page receives data indicating that the order has been cancelled, the fourth customer stage icon changes color from gray to orange, flashes, and the date and time the order was cancelled appears next to the fourth customer stage icon.

Adjacent to the retailer icon is a retailer stage icon that has a text label of “Order is placed.” When the retailer stage icon changes color from gray to green, it indicates that the order has been placed with the supplier by the retailer. In this embodiment, there is only one stage for the retailer to perform in the order fulfillment process, therefore when the web page receives data indicating that the retailer has placed the order, the retailer stage icon is changed to green and the arrow between the retailer and the supplier is changed to green as well.

Adjacent to the supplier icon are two supplier stage icons. The first supplier stage icon has a text label of “Received Order” and the second supplier stage icon has a text label of “Verified & Sent to Order to Plant.” When the web page receives data indicating that the order has been received by the supplier from the retailer, the first supplier stage icon changes color from gray to green, and the date and time the order was received will appear next to the first supplier stage icon. Similarly, when the web page receives data indicating that the order has been verified by the supplier and sent to the manufacturing plant, the second supplier stage icon changes color from gray to green and the date and time the order was received appears next to the second supplier stage icon, and the arrow between the supplier icon and the manufacturing icon changes from gray to green.

Adjacent to the manufacturer icon are four manufacturer stage icons. The first manufacturer stage icon has a text label of “Received Order,” the second manufacturer stage icon has a text label of “Order in Production,” the third manufacturer stage icon has a text label of “Scheduled to ship to Home Direct,” and the fourth manufacturer stage icon has a text label of “Shipped to Home Direct.” In this embodiment, Home Direct is the name of the shipper. When the web page receives data indicating that the order has been received by the manufacturer from the supplier, the first manufacturer stage icon changes color from gray to green, and the date and time the order was received appears next to it. Similarly, when the web page receives data indicating that the order is in production at the manufacturer, the second manufacturer stage icon changes color from gray to green and the date and time the order entered production appears next to the second manufacturer stage icon. When the web page receives data indicating a scheduled ship date for the finished product from the manufacturer, the third manufacturer stage icon changes color from gray to green and the scheduled ship date appears next to the third manufacturer stage icon. When the web page receives data indicating that the product has been shipped to Home Direct (the shipper in this case), the fourth manufacturer stage icon changes color from gray to green and the date the order shipped appears next to the fourth manufacturer stage icon, and the arrow between the manufacturing icon and the shipper icon changes from gray to green.

Adjacent to the shipper icon are four shipper stage icons and two informational icons. The first shipper stage icon has a text label of “Received Product,” the second shipper stage icon has a text label of “Contacted Member,” the third shipper stage icon has a text label of “Scheduled Delivery” and the fourth shipper stage icon has a text label of “Successful Delivery to Member.” When the web page receives data indicating that the product has been received by the shipper, the first shipper stage icon changes color from gray to green, and the date and time the product was received appears next to it. Similarly, when the web page receives data indicating that the shipper contacted the customer (member), the second shipper stage icon changes color from gray to green and the date and time the contact occurred appears next to the second shipper stage icon. When the web page receives data indicating a scheduled delivery date from the shipper, the third shipper stage icon changes color from gray to green and the scheduled delivery date and time appears next to the third shipper stage icon. When the web page receives data indicating that the product has been successfully delivered, the fourth shipper stage icon changes color from gray to green and the date and time the product was delivered appears next to the fourth shipper stage icon, and the arrow between the shipper icon and the customer icon changes from gray to green.

The first informational icon has a text label of “Member Info Problem” and the second informational icon has a text label of “Member Cancelled at Pre-Call.” When the web page receives data indicating that there is a problem with customer (member) information, the first informational icon changes color from gray to orange, and flashes on and off. The date and time the problem was received appears next to the flashing icon. Similarly, when the web page receives data indicating that an order has been cancelled, the second informational icon changes color from gray to orange and flashes on and off. The date and time the cancellation occurred appears next to the flashing second informational icon.

The invention also encompasses a graphic display where additional information can be displayed if desired by the user. For example, such functionality could be provided by drill down capability or “mouse over” capability. In this particular embodiment, mouse over capability is implemented. A user wishing to get additional information can move the cursor over a part of the web page and additional information will pop up. An example of this is a user moving the cursor over the shipper. In doing so, the shippper's name, address and phone number appears on the screen. When the customer movers the cursor near the customer information the UPC, quantity, description of each product ordered appears on the screen.

The web page display has a plurality of buttons at the bottom of it. In the embodiment depicted in FIG. 2, there are four buttons however the number of buttons may vary with different embodiments of the invention. Namely, an update member button for updating member information, a order replacement button for ordering the exact replacement of an item, a cancel button for canceling an order, and a warranty button, for replacing a product under warranty.

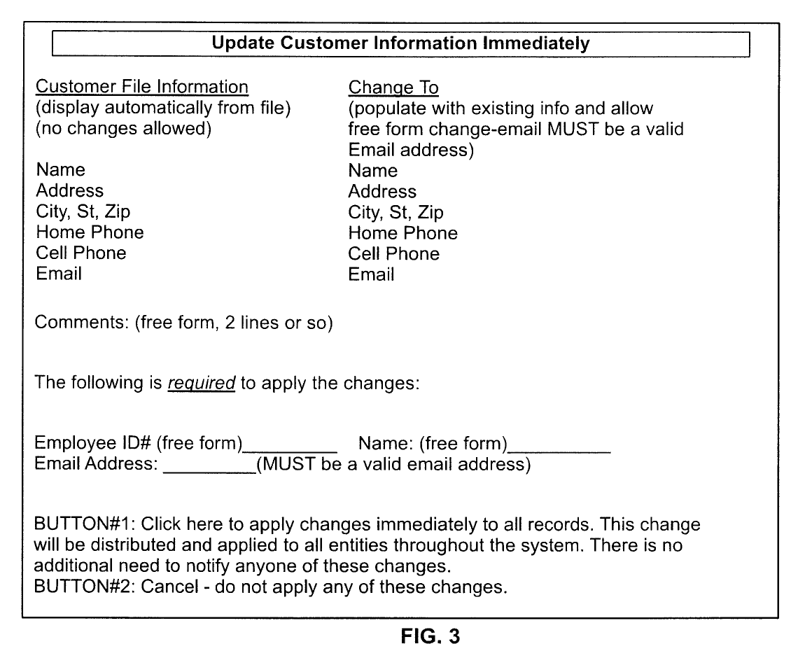

If a user logs onto the web site and while of the web page clicks the update member button on the web page, an update screen pops up on the web page. An example of such a screen is shown in FIG. 3. The update screen displays the customer name, address, city, state, zip code, home phone number, cell phone number, e-mail as retrieved from the first database. The update screen also includes similar fields in which to input new information. The fields for new information are initially populated with existing information but allow the user to make changes to that information. There are two lines for the input of text comments. The embodiment shown in FIG. 3, is an update screen that could be used by the retailer, the supplier or the shipper and therefore, in this embodiment the following is required in order to apply changes made to the information: an employee ID, employee name, and e-mail address (checked for validity). A similar screen used by the customer would not require an employee ID, employee name, and e-mail address in order to make the changes. Determination of which form of update screen is shown on the display is determined by the user logon to the web site. At the bottom of the update screen there are two buttons. The first button is clicked to apply the changes immediately to all records. The second button allows the user to cancel the changes. Once the changes are accepted, the popup window closes and a window is displayed with the message “New Customer Information Has Been Applied. Click here to return to the Pro-Tracker.”

The website will send the updated record and the date and the time to the first database via FTP. When received by the first database, the changes are applied to the records. When the web page receives the next update, the first informational icon will change from either gray (if the web page had not previously received data indicating that there was a problem with customer (member) information) or orange (if the web page had previously received data indicating that there was a problem with customer (member) information) to green and the date and time of the information update will appear next to the first informational icon. The changes are passed to the ordering and scheduling systems of the supplier and an alert message is sent to the retailer and shipper advising them that there has been a change in the records. In other embodiments, an alert message for the retailer and the shipper would appear on a special screen that each would have on the web site.

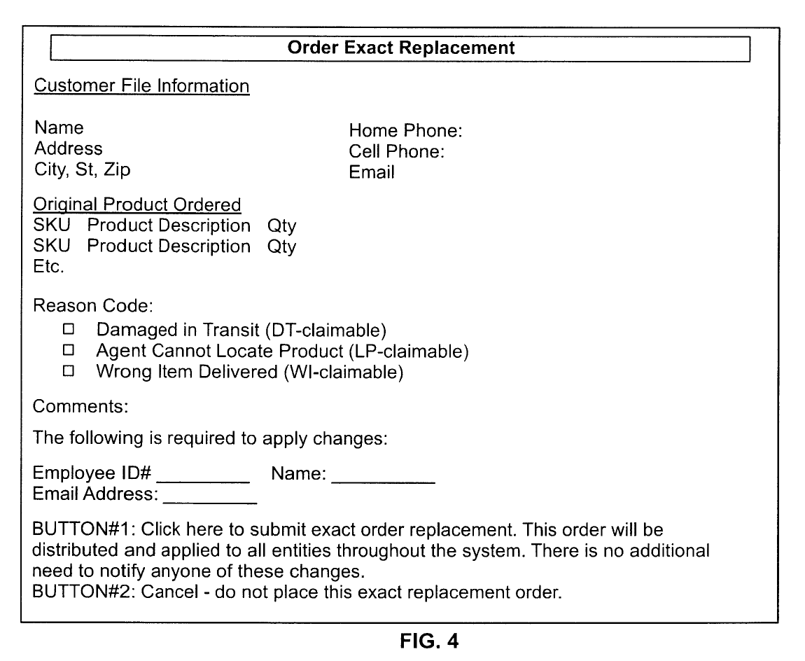

If a user clicks the order replacement button on the web page, an order exact replacement screen pops up on the web page and displays existing information from the purchase order and waybill as retrieved from the first database. An example of such a screen is shown in FIG. 4. The customer name, address, city, state, zip code, home phone, cell phone, email, the original products ordered, the UPC and SKU number for each ordered product, the description of each product and the quantity ordered are retrieved from the first database and displayed.

The order exact replacement screen has fields for the user to input comments, employee ID, employee name and e-mail address (checked for validity). The embodiment shown in FIG. 4, is an order exact replacement screen that could be used by the retailer, the supplier or the shipper and therefore, in this embodiment the following is required in order to apply changes made to the information: an employee ID, employee name, and e-mail address (checked for validity). A user can check one of three codes to indicate the reason for the replacement. The reason codes are the following: “Damaged in Transit (DT—claimable),” “Agent Cannot Locate Product (LP—claimable),” and “Wrong Item Delivered (WI—claimable).” Mouse over reason codes are available to explain to the user what it meant by “Damaged in Transit.” When the cursor is moved over “Damaged in Transit” an explanation such as “ripped, torn or dirty product” will appear. For “Agent Cannot Locate Product” an explanation such as “product was lost at agent and a re-order is necessary” will appear. For “Wrong Item Delivered” an explanation such as “size, style” will appear.

Two buttons appear at the bottom of the screen. The user clicks the first button to submit the order for an exact replacement. The second button allows the user to cancel their inputs and to not to place an exact replacement order. Once the changes are accepted the popup window closes and a window is displayed with the message “Exact order placement has been processed. Click here to return back to the Protracker.” The website will send the updated record and the date and the time to the first database via FTP. When received by the first database, the changes are applied and passed to the second database. The new product order is then applied to the appropriate ordering and scheduling systems and the retailer is sent an alert notifying them of this activity. If a damaged or unacceptable product must be picked up and returned, a request for pickup and return is sent to the shipper to schedule.

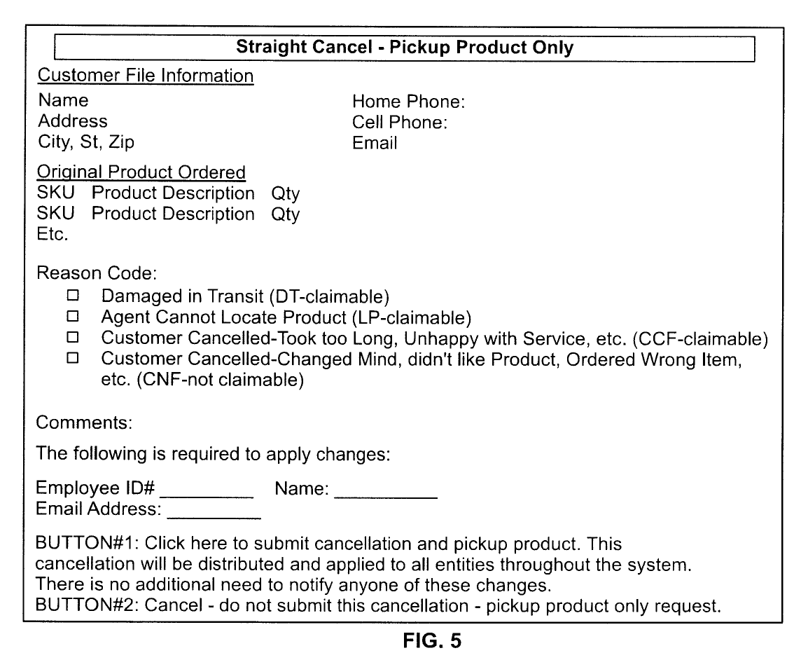

If a user (retailer, supplier or shipper) clicks the cancel button on the web page, a cancel screen pops up on the web page and displays existing information from the purchase order and waybill as retrieved from the first database. An example of such a screen is shown in FIG. 5. The customer name, address, city, state, zip code, home phone, cell phone, email, the original products ordered, the UPC and SKU number for each ordered product, the description of each product and the quantity ordered are retrieved from the first database and displayed. The order exact replacement screen has fields for the user to input comments, employee ID, employee name and e-mail address (checked for validity). The embodiment shown in FIG. 5, is a cancel screen that could be used by the retailer, the supplier or the shipper and therefore, in this embodiment the following is required in order to apply changes made to the information: an employee ID, employee name, and e-mail address (checked for validity). A user can check one of four codes to indicate the reason for cancellation. The reason codes are the following: “Damaged in Transit (DT—claimable),” “Agent Cannot Locate Product (LP—claimable),” “Customer Cancelled—Took too long, unhappy with service, etc. (CCF claimable),” and “Customer Cancelled—Changed Mind, didn't like product, ordered wrong item, etc. (CNF—not claimable).” Mouse over reason codes are available to explain to the user what it meant by “Damaged in Transit.” When the cursor is moved over “Damaged in Transit” an explanation such as “ripped, torn or dirty product” will appear. For “Agent Cannot Locate Product” an explanation such as “product was lost at agent and a re-order is necessary” will appear. For “Customer Cancelled” (service related)—an explanation such as “order took too long, unhappy with service etc.” will appear. For “Customer Cancelled” (customer choice) an explanation such as “changed mind, didn't like product, ordered wrong product or size etc.” will appear.

Two buttons appear at the bottom of the screen. The user clicks the first button to submit the cancellation. The second button allows the user to not to place the cancellation. Once the changes are accepted the popup window closes and a window is displayed with the message “Cancellation—Pickup Product Only has been processed. Click here to return back to the Protracker.” The website will send the updated record and the date and the time to the first database via FTP. When received by the first database, the changes are applied to the first database records and passed to the second database. The cancellation of the order is then applied to the appropriate ordering and scheduling systems and the retailer is sent an alert notifying them of this activity. If an unacceptable product must be picked up and returned, a request for pickup and return is sent to the shipper to schedule. Applying the cancellation to the first database record will cause the second informational icon and the fourth customer stage icon to change to orange and flash on the web page when the web page is updated.

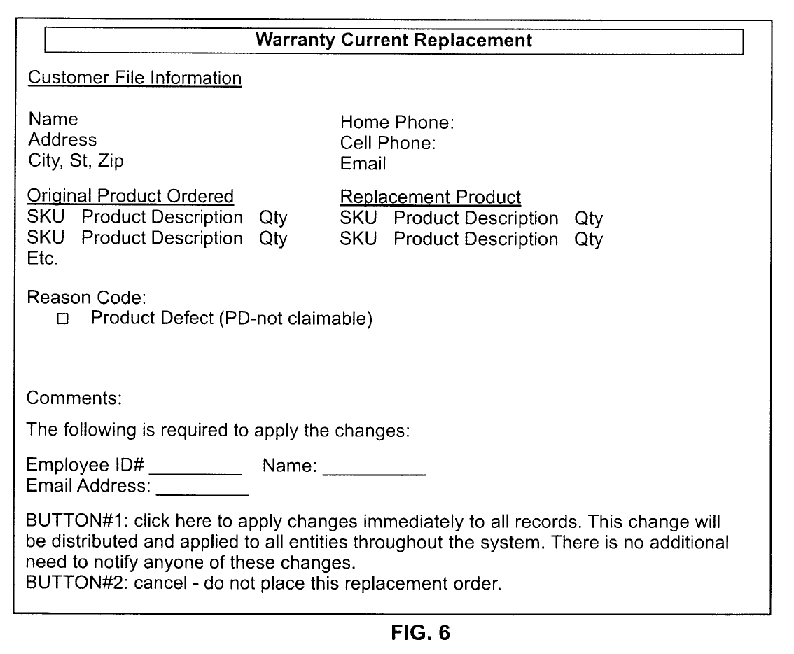

If a user clicks the warranty button on the web page, a warranty screen pops up on the web page and displays existing information from the purchase order and waybill as retrieved from the first database. An example of such a screen is shown in FIG. 6. The customer name, address, city, state, zip code, home phone, cell phone, email, the original products ordered, the UPC and SKU number for each ordered product, the description of each product and the quantity ordered are retrieved from the first database and displayed. The warranty current replacement screen has fields for the user to input the SKU for the replacement product and the product description, the quantity, comments, employee ID, employee name and e-mail address (checked for validity). The current product SKU is matched by the web page with an appropriate replacement product SKU. The embodiment shown in FIG. 6, is a warranty current replacement screen that could be used by the retailer or the supplier and therefore, in this embodiment the following is required in order to apply changes made to the information: an employee ID, employee name, and e-mail address (checked for validity). A user can check one code to indicate the reason for cancellation. The reason code is the following: “Product Defect (PD—not claimable).” A mouse over reason code is available to explain to the user what it meant by “Product Defect.” When the cursor is moved over “Product Defect” an explanation such as “poor tailoring, poor sewing, sagging, etc.” will appear.

Two buttons appear at the bottom of the screen. The user clicks the first button to submit the warranty current replacement. The second button allows the user to not to place the warranty current replacement. Once the changes are accepted the popup window closes and a window is displayed with the message “Warranty—Current Product Order Replacement has been processed. Click here to return back to the Protracker.” The website will send the updated record and the date and the time to the first database via FTP. When received by the first database, the changes are applied to the database record and passed to the second database. The new order is then sent to the appropriate ordering and scheduling systems and the retailer is sent an alert notifying them of this activity. If an unacceptable product must be picked up and returned, a request for pickup and return is sent to the shipper to schedule.

The retailer, supplier and shipper can update a customer's delivery information by accessing the web page via the Internet and selecting the button that says “Update Member” information. When that button is clicked a screen will appear that lets the retailer, supplier, and shipper enter the correct information. In some cases, both the phone number of the customer may be incorrect and the shipper is the first to discover it when the customer is called to arrange a delivery time. In those cases, the shipper may be unable to determine the correct customer delivery information and instead of updating the customer information the shipper may send an electronic message to the supplier alerting it to the information problem. The supplier then passes that information to the first database and which uploads the alert to the web site causing the first information icon to change color to orange.

In general the customer, the retailer, the supplier, the manufacturer, and the shipper can logon to the web site and view the web page displaying the status of an order. The visual depicted on the web page enables a user to quickly determine the status of the order, any cancellation or replacement of the order. The order being viewed is in green, any related orders are listed in gray below the order being viewed. Clicking on any of related orders will bring up the visual depiction of that order.

In another embodiment a user could click an icon on the screen to bring up a box for typing in a text message. The message can then be sent one of the entities and a live person can text message a response back.

In another embodiment there may be buttons on the web page to allow at least one entity to view metrics relating to their function in the order fulfillment. There may also be buttons on the web page that allow at least one entity to view at least one other entity's metrics with regard to the order. Examples of metrics that may be obtained are metrics that are performance based, cost based, quantity based, or error based. Other metrics may also be obtained.

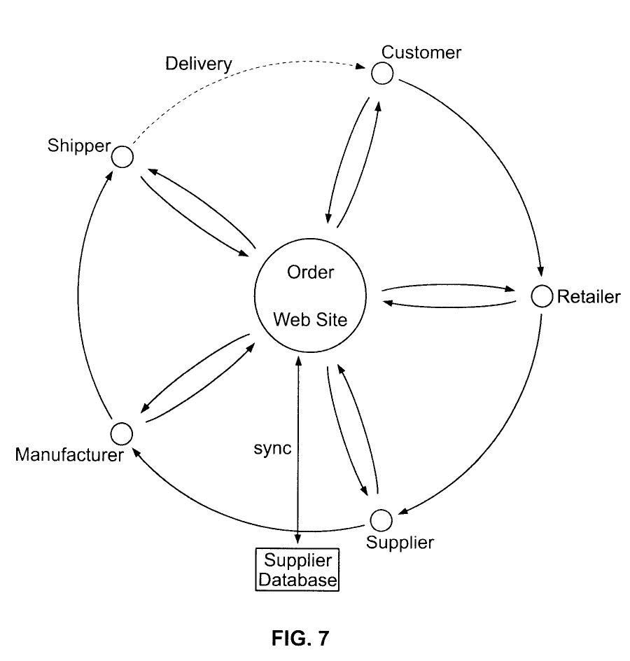

According to an alternative embodiment of the invention, there is illustrated in FIG. 7 another possible implementation of the invention. In this arrangement, there are illustrated 5 different entities: (1) customer, (2) retailer, (3) supplier, (4) manufacturer, and (5) shipper. A customer places an order through a retailer. This can be accomplished by a customer making a product selection at a store for the retailer, or the customer selecting a product from an online retail website. Other options or placing an order are possible as well; for example, a customer may contact a retailer by telephone and place an order.

After creation of the order, the order information may be supplied to the supplier, an entity that is capable of fulfilling the order. The order information may be supplied to the supplier electronically, for example, through an Electronic Data Interchange (EDI) system, or through other ways, such as by telephone or email. In fact, each of the outer links in the illustration may be arranged by an EDI system. In other words, communications concerning an order between the customer and retailer, between the retailer and supplier, between the supplier and the manufacturer, and between the manufacturer and the shipper, may be performed conventionally, such as telephonically, through email or through an EDI system. As illustrated by a dotted line, the information link between the shipper and customer may limited, such as by telephone, just in case of problems.

Each of the separate parties may be enabled to access the order website obtain information about the current status of an order. Of course, the order website may contain information about a plurality of orders, so any of the separate parties may have access only to a subset of the total information available on the website. For example, the customer may have access only to order information on the order website for orders that were placed by that customer. In addition, the system may be configured to allow each of the separate entities to modify information relating to an order. The system may further be configured to limit the ability for a particular entity to modify the order information to only that subset of information that involves the activities of that particular entity. For example, the shipper may be limited to modifying or updating the customer address information, such as by supplying ZIP code or other information relating to the delivery of the product.

According to an embodiment of the invention, information for a particular order on the order website is supplied by the supplier from information from a supplier database. The supplier database as illustrated may represent merely a portion of a larger database maintained by the supplier. The portion illustrated, for example, may contain just the information necessary to support the order information on the order website. The supplier database and the order website may be arranged so that a syncing operation is performed periodically where differences between order information on both systems are determined and resolved. For example, the customer may have updated or modified the address information on the order website. During the next syncing cycle, this change will be discovered and the updated address information may be applied to the appropriate order information in the supplier database. Alternatively, in the event information in the supplier database is updated, the corresponding information in the order website for a particular order may be updated during the next syncing cycle.

Thus, as illustrated in FIG. 7, there is shown an embodiment of the invention where a plurality of separate entities that are involved in the creation, processing, and fulfillment of an order have the ability, through the order website, to view and potentially modify information relating to an order. At the same time, each of the parties may communicate conventionally through other communications links, such as email, telephone, EDI system, etc. A supplier database can periodically perform a syncing operation to resolve differences, usually updates or modifications to order information on the order website, that are determined between the order website and a supplier database.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of displaying the progress, through a plurality of separate entities each externally linked by a network to a display and a data repository, of an order for a product not carried in inventory, the method comprising:
receiving purchase order information, generated by a first entity of the plurality of entities, comprising identification of the product, a customer's name, and a delivery address for the product;
receiving order status information, generated by a second entity of the plurality of entities, indicating that the order has been received by the second entity;
receiving, from a third entity of the plurality of entities, manufacturing status information associated with the order;
receiving, from a fourth entity of the plurality of entities, shipper status information associated with the order;
storing in the data repository the received purchase order information, order status information, manufacturing status information, and shipper status information; and
in response to user input, displaying on the display at least a current status of the purchase order information, the order status information, the manufacturing status information, and the shipper status information.

2. The method of claim 1, wherein the user input is generated by a customer.

3. The method of claim 1, wherein the first entity is a retailer, the second entity is a supplier, the third entity is a manufacturer, and the fourth entity is a shipper.

4. The method of claim 3, wherein the displaying step further comprises displaying a representation of a sequence of at least some functions performed by each entity in fulfillment of the order and indicating when each function has been completed.

5. The method of claim 1, wherein the network is the internet and the displaying step is accomplished by a web based display.

6. The method of claim 5, wherein the first entity is a plurality of retailers, the second entity is a supplier, the third entity is a manufacturer, and the fourth entity is a shipper.

7. A method of displaying the progress, through a plurality of separate entities each externally linked by a network to a display and a first database, of an order for a product that is not manufactured until ordered by a customer, the method comprising:
storing in the first database and a second database purchase order information, generated by a first entity of the plurality of entities and comprising identification of the product, the customer, and a delivery address for the product;
storing in the first database and the second database order status information generated by a second entity of the plurality of entities, indicating that the order has been received by the second entity;
storing in the first database and the second database manufacturing status information received from a third entity of the plurality of entities and related to the order;
storing in the first database and the second database shipper status information received from a fourth entity of the plurality of entities and related to the order;
determining a difference between information contained in the first and second databases, wherein the information is selected from the group consisting of purchase order information, order status information, manufacturing information, and shipper information;
in response to user input, retrieving from the first database at least a current status of the purchase order information, the order status information, the manufacturing status information, and the shipper status information; and
displaying at least the current status of the purchase order information, the order status information, the manufacturing status information, and the shipper status information.

8. The method of claim 7 further comprising updating the first database based on the difference found in the determining step.

9. The method of claim 8, wherein the first entity is a retailer, the second entity is a supplier, the third entity is a manufacturer, and the fourth entity is a shipper.

10. The method of claim 9 further comprising updating the second database based on the difference found in the determining step.

11. The method of claim 10, wherein at least the second database is managed by the supplier.

12. The method of claim 10, wherein the second database is connected to and exchanges information with the supplier's ordering and scheduling systems.

13. The method of claim 10, wherein the network is the internet and the displaying step is accomplished by a web based display and the web based display receives information directly from entities chosen from the group consisting of the customer, the retailer, the supplier, the manufacturer and the shipper.

14. The method of claim 10, wherein the determining step is performed periodically.

15. The method of claim 13 further comprising canceling the order in response to user input received by the web based display.

16. The method of claim 13 further comprising graphically indicating on the web based display that there is a problem with customer information.

17. A method for tracking a fulfillment process of a product from ordering through manufacturing and delivery, the method comprising:
receiving into a first data repository, from a retailer, purchase order information for the product including identification of the product, a customer, retailer identification, and delivery information, wherein the product is not carried in inventory by the retailer or a manufacturer;
receiving into the first data repository, from a supplier, order status information including a first date identifying when an order was received by the supplier, and a second date identifying when the order was sent by the supplier to the manufacturer;
receiving into the first data repository, from the manufacturer, manufacturing status information including a third date identifying when production of the product began, and a fourth date identifying when the product was sent to a shipper;
receiving into the first data repository, from the shipper, shipper status information including a fifth date identifying when the product was received from the manufacturer, a scheduled delivery date, and a delivery date of the product by the shipper;
storing in a second data repository the purchase order information, order status information, manufacturing status information, and shipper status information; and
in response to user input, retrieving from the first data repository and displaying on a display at least some of the current status information for the purchase order information, order status information, manufacturing status information, shipper status information, and displaying a representation of the sequence of functions in the fulfillment process for the customer, the retailer, the supplier, the manufacturer, and the shipper, wherein at least a part of the representation changes color to indicate that a function in the sequence has been completed, and wherein the retailer, supplier, manufacturer and shipper are each externally linked by a network to the first data repository.

18. The method of claim 17 further comprising receiving updated delivery information from the shipper.

19. The method of claim 17 further comprising receiving updated delivery information from the customer, wherein the customer is externally linked by the network to the first data repository.

20. The method of claim 17, wherein the displaying step further comprises changing the color of at least a part of the representation to indicate a problem in the fulfillment process.

21. The method of claim 17 further comprising receiving a request to cancel the order from the customer and canceling the order based on that request, wherein the customer is externally linked by the network to the first data repository.

22. The method of claim 21 further comprising receiving from the customer a new order for a second product.
